(19) United States
(12) Patent Application Publication
(10) Pub. No.: US 2012/0017769 A1
(43) Pub. Date: Jan. 26, 2012

(54) COOKING APPARATUS

(76) Inventors: Kazuhiko Inoue, Aichi-ken (JP); Eiji Suzuki, Aichi-ken (JP); Shinichi Kaga, Aichi-ken (JP); Yukimasa Takeda, Aichi-ken (JP); Akihiko Hirano, Aichi-ken (JP)

(21) Appl. No.: 13/060,101

(22) PCT Filed: Aug. 20, 2009
(86) PCT No.: PCT/JP2009/064553

§ 371 Date: Oct. 11, 2011

(30) Foreign Application Priority Data
Aug. 20, 2008 (JP) 2008-212026
Jul. 28, 2009 (JP) 2009-175753

(51) Int. Cl. A47J 27/62

(52) U.S. Cl. 99/331

(57) ABSTRACT

Object

A cooking apparatus, wherein, independent of the quantity and the temperature of the foodstuff contained in a cooking chamber of the cooking apparatus, the food stuff can be cooked in a consistent time period by initial-heating processing and main-heating processing.

Means of Solution

A cooking device is provided with a controller for performing initial-heating processing before a transition to main-heating processing. The initial-heating processing is processing which, when the temperature in a cooking chamber is dropped by a foodstuff placed in the cooking chamber, controls supply of electricity to a heater provided in the cooking chamber, and the control is performed such that the temperature in the cooking chamber rises along temperature rising line which defines a temperature rise rate at which the temperature in the cooking chamber reaches a predetermined preset cooking temperature from an initial-heating start temperature, which is set on the basis of a previously determined time period for initial heating, after the time period for initial-heating has elapsed.

Selected Figure

FIG. 7

### TECHNICAL FIELD OF THE INVENTION

This invention relates to a cooking apparatus.

1. Background Technologies

In the Prior Art Publication 1, a cooking apparatus such as steam convection oven is disclosed. The cooking apparatus comprises a cooking chamber for cooking foodstuff, a heater for heating the cooking chamber and a fan for making convectional air flow in the cooking chamber and it is configured to cook a foodstuff contained in the cooking chamber with hot air flow generated by a heater and a fan. In this cooking apparatus, temperature of the cooking chamber is controlled to be predetermined cooking temperature by activating the heater in response to the temperature detected by a cooking chamber temperature sensor. The cooking apparatus controls inside temperature of the cooking chamber as follows; in pre-heating processing, activates the heater to rise the inside temperature of the cooking chamber up to the temperature suitable for cooking the foodstuff in response to the temperature detected by the cooking chamber temperature sensor. After the pre-heating processing is completed, when the inside temperature of the cooking chamber is dropped by placing the foodstuff in the cooking chamber, it activates the heater to rise inside temperature of the cooking chamber up to predetermined cooking temperature in response to the temperature detected by the cooking chamber temperature sensor as initial-heating processing. After the initial-heating processing is completed, it activates the heater to maintain inside temperature of the cooking chamber at predetermined cooking temperature during predetermined cooking time period as main-heating processing.

2. Prior Art

Patent Publication 1: Japanese Laid-open Publication No.2002-364852

### DISCLOSURE OF THE INVENTION

### Problems to be Solved by the Invention

In the cooking apparatus of Patent Publication 1, initial-heating processing is performed to resume cooking chamber temperature up to predetermined cooking temperature when the cooking chamber temperature is dropped by foodstuff being placed in the cooking chamber after the pre-heating processing. However, the time period required for resuming the cooking chamber temperature may vary depending on the mass and temperature of the foodstuff. The variety of heating time in initial heating process may result uneven quality of cooked foodstuff Therefore, a user must check the condition of the foodstuff during main-heating processing and it is troublesome.

### Means to Solve the Problem

An object of the present invention is to provide a cooking apparatus comprising a cooking chamber which made to contain a foodstuff inside, a heater for heating interior of said cooking chamber, an electric fan generating convectional air flow in the cooking chamber, a cooking chamber temperature sensor for detecting inside temperature of cooking chamber, cooking temperature setting means for preset cooking temperature suitable for foodstuff contained in the cooking chamber and a controller for controlling inside temperature of the cooking chamber by performing a pre-heating processing which rises inside temperature of the cooking chamber up to said predetermined cooking temperature by controlling electricity supply for the heater in response to value detected by the cooking chamber temperature sensor before said foodstuff being placed in the cooking chamber and a main-heating processing which rises and maintains inside temperature of cooking chamber at said predetermined cooking temperature by controlling electricity supply for the heater in response to value detected by the cooking chamber temperature sensor when the inside temperature of the cooking chamber is dropped by the food stuff being place in the cooking chamber. Wherein, said controller comprising a control means performing an initial-heating processing before transition to said main-heating processing which rises inside temperature of the cooking chamber being match with a temperature rising line that regulates temperature rising rate which provided in relation of elapsed time in predetermined initial-heating processing time period and temperature change from initial-heating start temperature to said preset cooking temperature in response to temperature detected by the cooking chamber temperature sensor when the inside temperature of the cooking chamber is dropped by the food stuff being place in the cooking chamber.

In a cooking apparatus described above, which comprises a control means performing the initial-heating processing before a transition to the main-heating processing which rises inside temperature of the cooking chamber to be match with a temperature rising line that regulates temperature rising rate which provided in relation of elapsed time in predetermined initial-heating processing time period and temperature change from initial-heating start temperature to said preset cooking temperature in response to temperature detected by the cooking chamber temperature sensor, it is possible to make the duration of foodstuff being cooked during initial-heating processing and main-heating processing consistent, even if the quantity and/or temperature of the foodstuff being placed in the cooking chamber varies. Thus, it is possible to achieve constant quality of cooked foodstuff.

In a cooking apparatus according to the present invention, it is preferred to comprise a steam generating device for supplying steam into said cooking chamber and said controller comprising a control means for controlling electricity supply for an electric heating means in the steam generating device together with said heater in response to value detected by the cooking chamber temperature sensor during said initial-heating processing. In this case, the foodstuff placed in the cooking chamber can be cooked with hot air flow generated by the heater and the fan or steam generated by steam generating device and with combination of these two. Also in this case, steam generating device is controlled by the controller, thus supply amount of steam into the cooking chamber can be controlled. Moreover, it is possible to provide better accuracy of cooking temperature control by controlling the supply of electricity to the heater and the steam generating device variably, thus the heater and the steam generating device can be activate simultaneously within the limit of electricity capacity provided with the cooking apparatus, in comparison with one that activate those in alternately.

In the case the inside temperature of said cooking chamber does not drop below the initial-heating start temperature when the foodstuff is placed in the cooking chamber, because of the quantity of the food stuff is small and/or temperature of the food is high, said controller stops supply of electricity to said heater until the cooking chamber temperature detected by the cooking chamber temperature sensor being match with the temperature rising line, thus the foodstuff can be cooked in consistent initial heating time period under control of said controller.

The cooking apparatus according to the present invention may be provided with a manual mode and a program mode. The manual mode, in which, cooking temperature and time period of main-heating processing can be set by a user. The program mode, in which, cooking temperature and time period of main-heating processing is preset. When the manual mode is selected, cooking can be done in conventional style which, the user checks progression during cooking. When the program mode is selected, the cooking apparatus performs the initial-heating processing and main-heating processing to provide consistent quality of the cooked foodstuff.

### BRIEF DESCRIPTION OF THE DRAWINGS

FIG. 1 is a front view of the cooking apparatus of the present invention.

FIG. 2 is a A-A line cross-sectional view in FIG. 1.

FIG. 3 is a B-B line cross-sectional view in FIG. 2.

FIG. 4 is a C-C line cross-sectional view in FIG. 2.

FIG. 5 is a plan view of operation panel.

FIG. 6 is a block diagram illustrates control device of the cooking apparatus of the present invention

FIG. 7 is a chart shows temperature and output of the heater during pre-heating process, initial-heating process and main-heating process in oven cooking mode (1).

FIG. 8 is a chart shows temperature and output of the heater during pre-heating process, initial-heating process and main-heating process in oven cooking mode (2).

FIG. 9 is a chart shows temperature and output of the heater during pre-heating process, initial-heating process and main-heating process in combined cooking mode.

### DESCRIPTION OF THE PREFERRED EMBODIMENTS

Hereinafter describe a steam convection oven which is an embodiment of cooking apparatus of the present invention referring to the drawings. A steam convection oven 10 comprises a cooking chamber 11 for accommodating foodstuff inside, a heater 20 for heating interior of the cooking chamber 11, an electric fan 30 for generating convectional flow of air heated by the heater 20 in the cooking chamber, a cooking chamber temperature sensor 13 for detecting interior temperature of the cooking chamber, a cooking temperature setting means for setting optimal temperature for cooking the foodstuff placed in the cooking chamber and a controller 70 for performing a pre-heating processing which preliminary rise the cooking chamber temperature up to preset cooking temperature by controlling supply of electricity to the heater 20 in response to the value detected by the cooking chamber temperature sensor 13 before the foodstuff being placed in the cooking chamber, and after the pre-heating processing, a main-heating processing which maintain the cooking chamber temperature at preset cooking temperature by controlling supply of electricity for the heater 20 in response to the value detected by the cooking chamber temperature sensor 13 when the cooking chamber temperature dropped after the foodstuff being placed in the cooking chamber 11. The controller 70 of the steam convection oven 10 comprises control means for performing an initial-heating process before a transition to the main-heating processing. The initial-heating processing which rises inside temperature of the cooking chamber 11 to be match with a temperature rising line that regulates temperature rising rate which provided in relation of elapsed time in predetermined initial-heating processing time period and temperature change from initial-heating start temperature to said preset cooking temperature in response to temperature detected by the cooking chamber temperature sensor 13 when the inside temperature of the cooking chamber is dropped by the food stuff being place in the cooking chamber 11.

The cooking apparatus 10 according to this embodiment has oven cooking mode, steam cooking mode and combined cooking mode. In the oven cooking mode, the foodstuff placed in the cooking chamber 11 is cooked with hot air flow generated by the heater 20 and the electric fan 30. In the steam cooking mode, the foodstuff placed in the cooking chamber 11 is cooked with steam that comes from the electric fan 30 and the steam generating device 40. In the combined cooking mode, cooking is done with hot air flow and steam generated by the heater 20, the electric fan 30 and the steam generating device 40. The cooking apparatus 10 has manual mode and program mode. In the manual mode, cooking modes described above, cooking temperature, steam thickness and main-heating time period are free to choose to suite cooking method for a foodstuff. In the program mode, cooking modes described above, cooking temperature, steam thickness and main-heating time period are preset according to the cooking method for a foodstuff

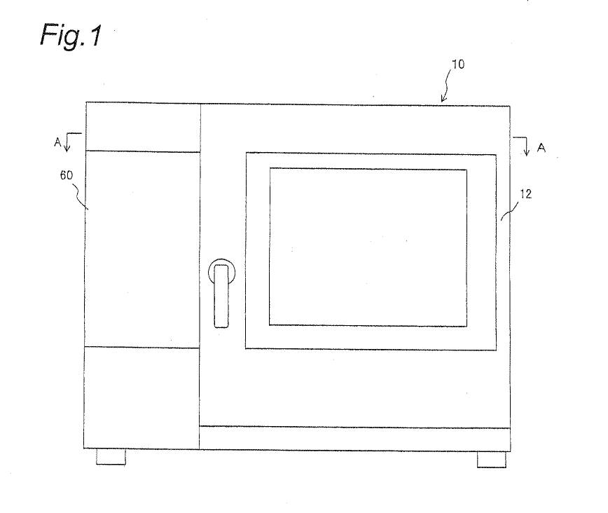

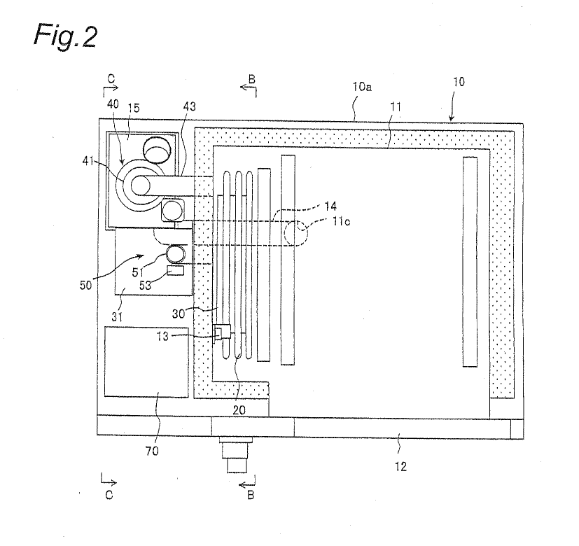

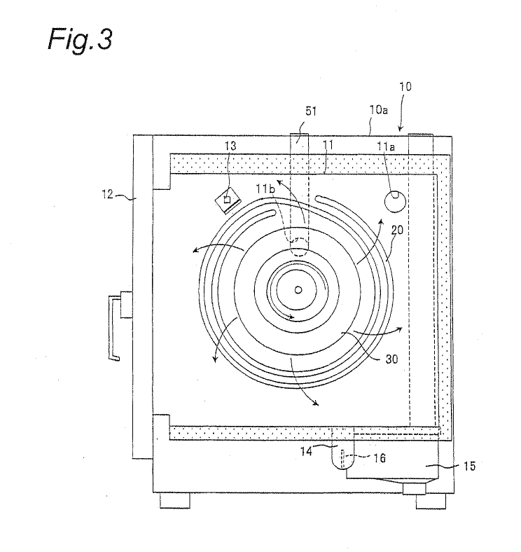

As illustrated in FIGS. 1 and 2, cooking chamber 11 is made to accommodate foodstuff for cooking. It has an opening in front face of box shaped outer shall and heat insulated door 12 is mounted for foodstuff to go through there. In the cooking chamber 11, a cooking chamber temperature sensor 13 utilizing thermocouple is placed for detecting inside temperature of cooking chamber 11. As illustrated in FIGS. 2 and 3, the cooking chamber 11 comprises a steam inlet 11a a passage for steam generated by steam generating device 40, a port 11b for air to go in and out from the cooking chamber 11 and a port 11c for draining water from the cooking chamber 11. The port 11c provided in cooking chamber 11 is connected with a drain tube 14. The drain tube 14 is connected with a drain tank 15 also act as drainage for steam generating device 40. The air in the cooking chamber 11 containing steam is discharged through drain tube 14 and drain tank 15. An exhaust temperature sensor 16 is provided in the drain tube 14 for detecting temperature of exhaust air.

As illustrated in FIGS. 2 and 3, the heater 20 is a conventional electric heater such as sheathed heater for heating interior of the cooking chamber 11 with supplied electricity and is disposed inside left wall of the cooking chamber 11 in circular shape.

As illustrated in FIGS. 2 and 3, the electric fan 30 is a centrifugal fan such as sirocco fan for generating convectional air flow in the cooking chamber 11 with supplied electricity and is mounted on the left inside wall of the cooking chamber. The electric fan 30 is surrounded by the heater 20 which disposed in a circular shape. The electric fan 30 driven by a fan motor 31 blows the air onto the heater 20 to generate convectional flow of hot air in the cooking chamber 11.

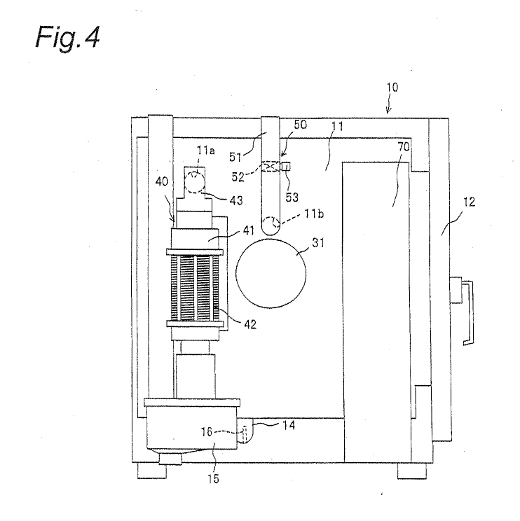

As illustrated in FIGS. 2 and 4, steam generating device 40 which supply steam into the cooking chamber 11 with supplied electricity and is disposed left side position of the cooking chamber in a casing 10a. The steam generating device 40 is an induction heating type steam generating device which comprises cylindrical shape steam generating vessel 41, an induction heater body consists of metallic stick shape electro conductive material disposed inside of the steam generating vessel 41 and an induction heating coil 42 wound around outer peripheral of the steam generating vessel 41. The heating coil 42 supplied with high frequency electric current heats the heater body to evaporate the water in the steam generating vessel 41 thus the steam generating device 40 generates steam. A steam supply tube 43 is disposed on the upper end of the steam generating vessel 41. The steam generated in the steam generating vessel 41 is flow into the cooking chamber 11 through the steam supply tube 43. The bottom end of the steam generating vessel 41 is attached to the drain tank 15 for draining the water in the cooking chamber 11. The water in the steam generating vessel 41 is discharged to outside through drain tank 15.

As illustrated in FIGS. 2 and 4, a vent device 50 is provided which comprises vent tube 51, vent valve 52 consists of butterfly valve disposed in the vent tube 51 and a vent valve motor 53 for activating the vent valve 52. The vent tube 51 is connected with the port 11b disposed in the left side wall of the cooking chamber 11 and back side of the electric fan 30. The vent valve 52 is rotatably disposed in the middle portion of the vent tube 51 and is driven by the vent valve motor 53 to vary its opening for adjusting the air flow through the vent tube 51. When the vent valve 52 of the vent device 50 opened with the electric fan 30 running, the air outside the cooking chamber 11 is introduced into the cooking chamber 11 through the vent tube 51. When the vent valve 52 opened with the electric fan 30 is not running, the air in the cooking chamber exhausted to the outside of the cooking chamber 11 by the steam supplied by steam generating device 40 or the steam vapored from the foodstuff through the vent tube 51.

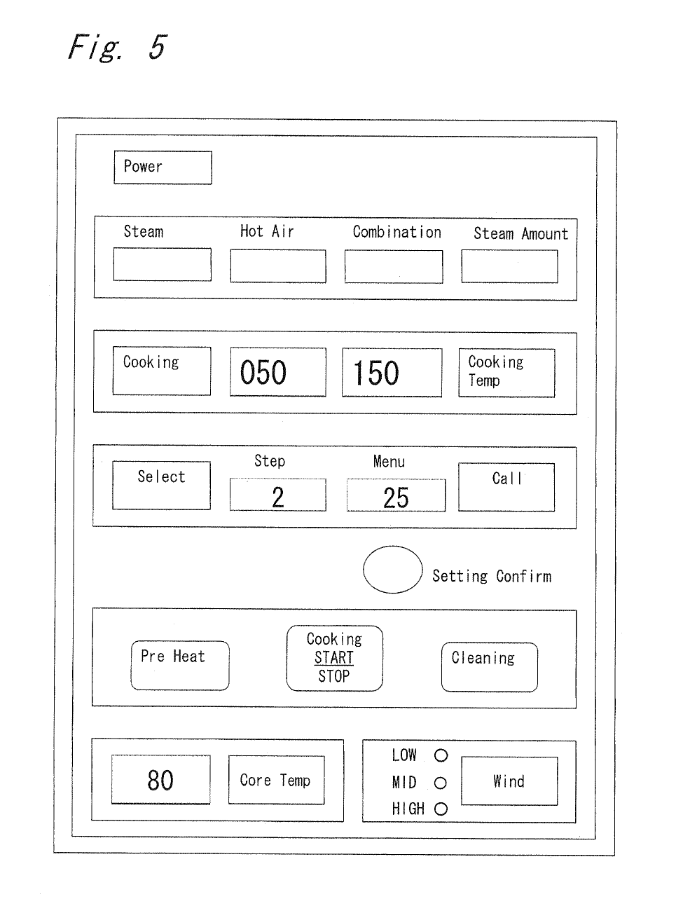

As illustrated in FIGS. 1 and 5, an operation panel 60 is provided for setting cooking mode, cooking temperature and cooking time (main-heating time period). The operation panel 60 comprises “Steam”, “Hot Air” and “Combination” buttons. These buttons are provided for selection of cooking modes which are steam cooking mode, oven cooking mode and combined cooking mode in manual cooking. The operation panel 60 comprises “Cooking Time” and “Cooking Temperature” buttons. These buttons are provided for setting cooking time (main-heating time period) and cooking temperature. The operation panel 60 comprises “Select” and “Menu” buttons. These buttons are provided for selecting pre-programmed cooking programs in the program mode in which said cooking mode, cooking temperature and cooking time (main-heating time period) are preset.

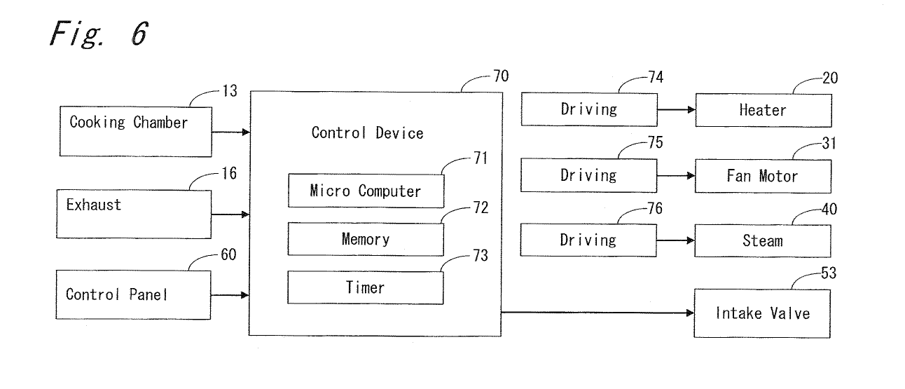

As illustrated in FIG. 6, the cooking apparatus 10 comprises the cooking chamber temperature sensor 13, the exhaust temperature sensor 16, the heater 20, the fan motor 31, the steam generating device 40, the vent device 50 and a controller 70 having microcomputer 71 which is connected with the operation panel 60. The controller 70 comprises a memory 72 and a timer 73. The cooking program in the program mode and temperature rising line during initial-heating processing are stored in the memory 72. The timer 73 is provided for counting elapsed time during initial-heating processing and main-heating processing. In this embodiment, temperature rising line is provided in relation of elapsed time of initial-heating processing and temperature range from initial-heating processing start temperature to preset main-heating processing temperature.

The controller 70 comprises drive circuits 74-76, which are connected to the heater 20, the fan motor 31 and the steam generating device 40. The driving circuit 74 is a phase control circuit, which changes electricity supply for the heater 20 by changing phase of voltage. The driving circuit 75 and 76 are inverter circuits, which changes electricity supply for the fan motor 31 and the steam generating device 40 by increasing or decreasing driving time of switching element. The controller 70 controls output of the heater 20, speed of the fan motor 31 and steam amount of the steam generating device 40 by means of the driving circuits 74-76 variably control the input electricity for the heater 20 , the fan motor 31 and steam generating device 40. In this embodiment, the driving circuits 74-76 are utilizing phase control circuit and inverter circuit. However, it is not limited to these. The variable control of supply electricity for devices 20, 31 and 40 may be accomplished by utilizing other circuit

The controller 70 comprises a control means which controls activation of the heater 20 as follows; rise the inside temperature of the cooking chamber 11 up to preset cooking temperature suitable for cooking the foodstuff in response to the temperature detected by the cooking chamber temperature sensor 13 in the pre-heating processing as the pre-heating processing, after the pre-heating processing, when the inside temperature of the cooking chamber 11 dropped by placing the foodstuff in the cooking chamber 11, rise the inside temperature of the cooking chamber 11 up to the preset cooking temperature again as the initial-heating processing and then after the initial-heating processing is completed, maintain the inside temperature of the cooking chamber 11 at preset cooking temperature during predetermined main-heating processing time period in response to the temperature detected by the cooking chamber temperature sensor 13.

The controller 70 comprises a control means for controlling activation of the heater 20 to rise the inside temperature of the cooking chamber 11 being match with the temperature rising line that regulates temperature rising rate which provided in relation of elapsed time in predetermined initial-heating processing time period and temperature change from initial-heating start temperature to said preset cooking temperature. The controller 70 is programed not to perform above-mentioned initial-heating processing when the manual mode is selected.

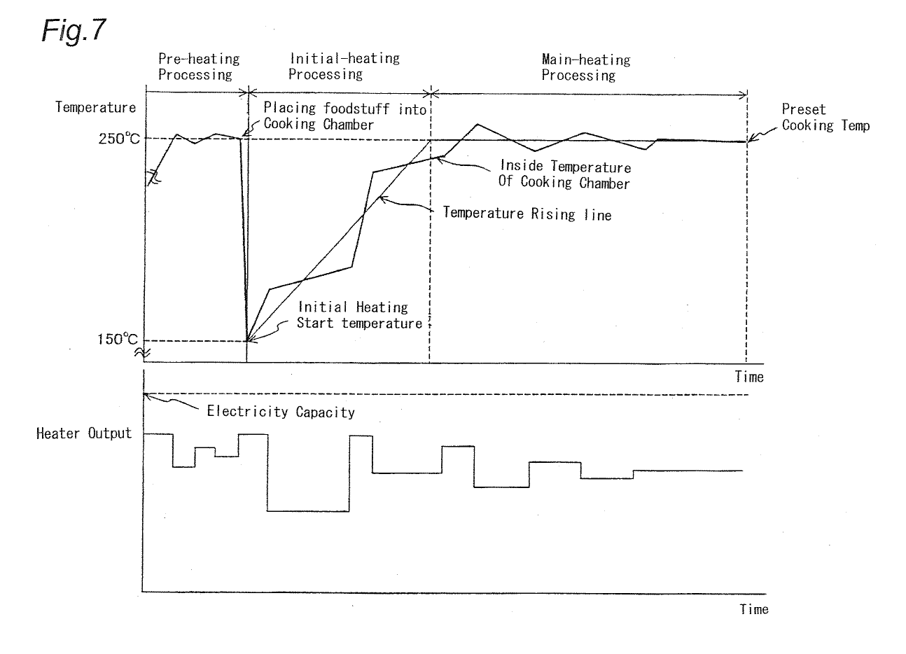

Hereafter, describe how the cooking apparatus 10 works in the oven cooking mode and the combined cooking mode under the programed mode. As illustrated in FIG. 7, in the oven cooking mode under the programed mode, the controller 70 controls electricity supply for the heater 20 to rise the inside temperature of the cooking chamber 11 up to preset cooking temperature (250 degree centigrade in this embodiment) in response to the temperature detected by the cooking chamber temperature sensor 13. When the inside temperature of the cooking chamber 11 reached to the preset cooking temperature, the controller 70 controls electricity supply for the heater 20 to maintain the preset cooking temperature as follows; when the detected temperature at cooking chamber temperature sensor 13 is higher than the predetermined upper limit temperature (255 degree centigrade in this embodiment), decrease electricity supply for the heater 20 by the driving circuit 74 and when the detected temperature at the cooking chamber temperature sensor 13 is lower than the predetermined lower limit temperature (245 degree centigrade in this embodiment), increase electricity supply for the heater 20 by the driving circuit 74.

After pre-heating processing completed, the inside temperature of the cooking chamber 11 may drop down to initial-heating start temperature (150 degree centigrade in this embodiment) by placing the foodstuff in the cooking chamber 11. The controller 70 performs above described initial-heating processing, so that the electricity supply for the heater 20 is controlled to match the inside temperature of the cooking chamber 11 with the temperature rising line stored in the memory 72. That is, the controller 70 controls the inside temperature of the cooking chamber to match with the temperature rising line as follows; increase the electricity supply for the heater 20 by the driving circuit 74 when the temperature detected by the cooking chamber temperature sensor 13 is lower than the temperature rising line and decrease the electricity supply for the heater 20 by driving circuit 20 when the temperature detected by the cooking chamber temperature sensor 13 is higher than the temperature rising line.

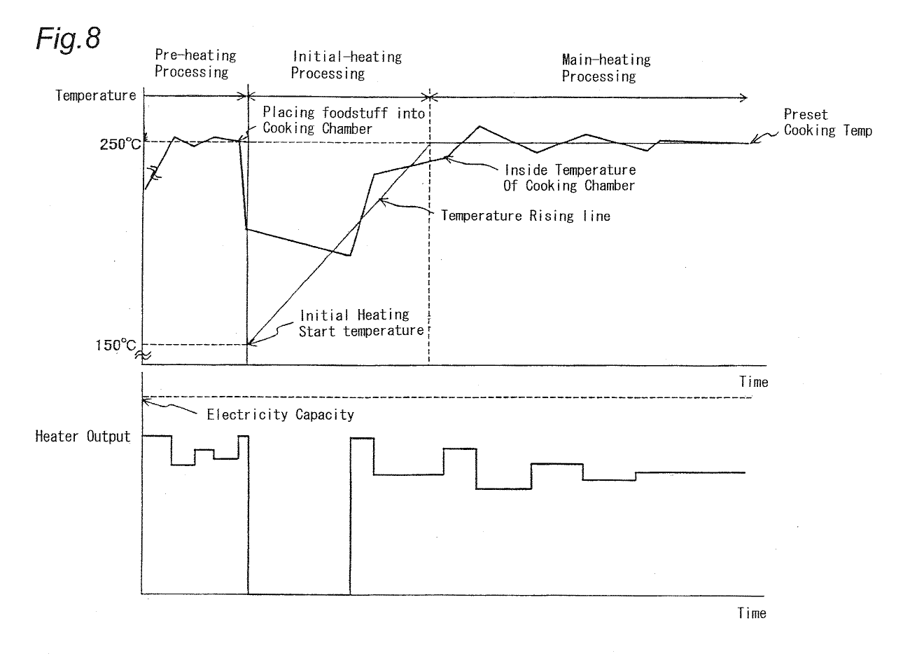

As illustrated in FIG. 8, the inside temperature of the cooking chamber 11 does not always drop. When temperature of a foodstuff is high, inside temperature of the cooking chamber may not drop down to initial-heating starting temperature. In this case, the controller 70 controls the inside temperature of the cooking chamber 11 in response to temperature detected by the cooking chamber temperature sensor 13 by not activating the heater 20 until detected temperature is going to match with the temperature rising line. After inside temperature of the cooking chamber 11 detected by the cooking chamber temperature sensor 13 falls on to the temperature on to the temperature rising line, the controller 70 maintains the inside temperature of the cooking chamber detected by cooking chamber temperature sensor 13 being match with the temperature rising line by controlling the heater 20.

After the initial-heating processing completed, the controller 70 maintains inside temperature of the cooking chamber 11 at preset cooking temperature during time period of the main-heating processing by controlling activation of the heater 20. That is, the controller 70 maintains inside temperature of the cooking chamber 11 at preset cooking temperature during time period of main-heating processing as follows; when temperature detected by the cooking chamber temperature sensor 13 reached the upper limit temperature which is predetermined degrees higher than the preset cooking temperature, decrease electricity supply for the heater 20 by the driving circuit 74, when detected temperature at cooking chamber temperature sensor 13 reached the lower limit temperature which is predetermined degrees lower than the preset cooking temperature, increase electricity supply for the heater 20 by the driving circuit 74.

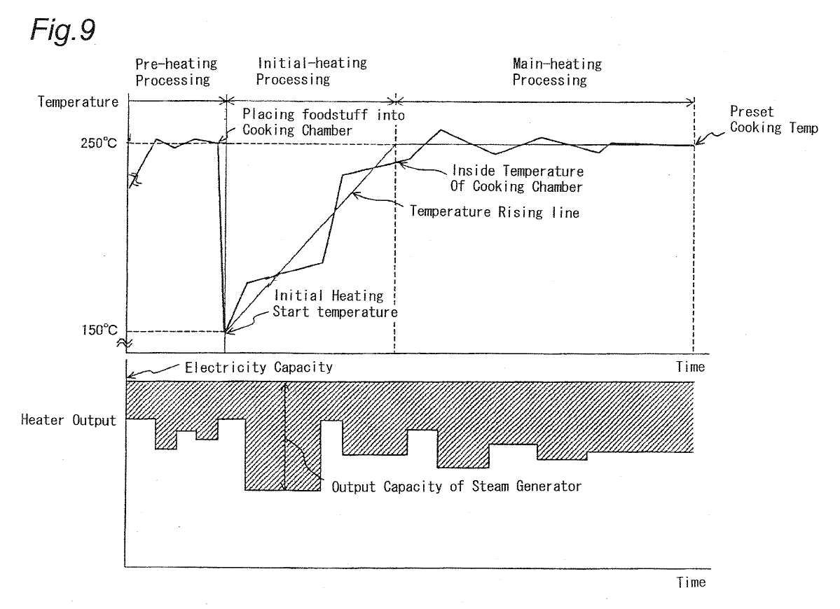

Next, in the combined cooking mode under the program mode, as illustrated in FIG. 9, same as described in the oven mode, the controller 70 activates the heater 20 to rise the inside temperature of the cooking chamber 11 up to the preset cooking temperature (250 degree centigrade in this embodiment) in response to the detected temperature at cooking chamber temperature sensor 13 in the pre-heating processing. After the pre-heating processing is completed, the inside temperature of the cooking chamber 11 drop down to nearby predetermined initial-heating start temperature (150 degree centigrade in this embodiment) by placing the foodstuff in the cooking chamber 11. The controller 70 performs the initial-heating process during initial-heating time period, controls the heater 20 to make inside temperature of the cooking chamber 11 being match with the temperature rising line stored in the memory 72. That is, the controller 70 controls the inside temperature of the cooking chamber 11 matching with the temperature rising line as follows; when the temperature detected by the cooking chamber temperature sensor 13 being lower than the temperature rising line, increase electricity supply for the heater 20 by the driving circuit 74 and when the temperature detected by the cooking chamber temperature sensor 13 being higher than the temperature rising line, decrease electricity supply for the heater 20 by the driving circuit 74. The controller 70 temporally activates the steam generating device 40 together with the heater 20 within the limit of electricity capacity regulated to the cooking apparatus 10 in the beginning of the initial-heating processing. Also, in the initial-heating processing of the combined cooking mode, when the foodstuff placed in the cooking chamber is small in amount or the temperature of the foodstuff is high, the controller 70 does not activate the heater 20 until the temperature detected by the cooking chamber temperature sensor 13 matches with the temperature rising line as same as described above in the initial-heating processing of the oven mode.

After the initial-heating processing is completed, the controller 70 controls activation of the heater 20 and the steam generating device 40 to maintain predetermined cooking temperature and predetermined steam thickness in the cooking chamber 11 during main-heating processing time period in main-heating processing. That is, the controller 70 maintains inside temperature of the cooking chamber 11 at preset cooking temperature during predetermined main-heating processing time period as follows; when temperature detected by the cooking chamber temperature sensor 13 reached the upper limit temperature which is predetermined degrees higher than the preset cooking temperature, decrease electricity supply for the heater 20 by the driving circuit 74, when detected temperature at cooking chamber temperature sensor 13 reached the lower limit temperature which is predetermined degrees lower than the preset cooking temperature, increase electricity supply for the heater 20 by the driving circuit 74. The controller 70 maintains the thickness of steam at preset steam thickness by controlling electricity supply for the steam generating device 40 through the driving circuit 76 in response to the temperature detected by the exhaust temperature sensor 16 within the electricity capacity regulated to the cooking apparatus 10.

In the cooking apparatus 10 constructed as described above, the controller 70 comprises the control means for controlling activation of the heater 20 to rise the inside temperature of the cooking chamber 11 being match with the temperature rising line which provided in relation of elapsed time in predetermined initial-heating processing time period and temperature change from initial-heating start temperature to preset cooking temperature. So that, it is possible to make cooking time period consistent even if the quantity and/or temperature of the foodstuff placed in the cooking chamber 11 varies. Thus, it is possible to achieve constant quality of cooked foodstuff without a user who frequently checking the cooking condition.

In the cooking apparatus 10 as described above, the temperature inside the cooking chamber 11 can be controlled in high accuracy, because the controller 70 comprises driving circuit 74 which variably controls input electricity to the heater 20. The controller 70 variably controls input electricity to steam generating device 40 through driving circuit 76 to control the amount of steam supply into the cooking chamber 11. Moreover, it is possible to provide better accuracy of cooking temperature control by controlling the supply of electricity to the heater and the steam generating device variably, thus the heater and the steam generating device can be activate simultaneously within the limit of electricity capacity provided with the cooking apparatus (the hatched area depicted in FIG. 9 shows electricity capacity), in comparison with one that activate those in alternately.

In the cooking apparatus 10, it controls the heater 20 not to activate until the detected temperature from the cooking chamber temperature sensor 13 to go match with the temperature rising line when the inside temperature of the cooking chamber 11 detected by cooking chamber temperature sensor 13 is higher than the initial-heating start temperature. Thus, the foodstuff can be cooked in consistent initial-heating time period even when the quantity of the foodstuff is small and/or the temperature of the foodstuff is high.

In the cooking apparatus 10, it is selectable to perform the initial-heating process or not. When initial-heating process performing is chosen, quality of the cooked foodstuff is consistent. When no initial-heating process is chosen, the conventional style cooking which the user checking the progression of cooking is possible. That is, two way of cooking can be done with single cooking apparatus.

In the cooking apparatus 10, it is selectable between the manual mode and the program mode. The manual mode, in which, cooking temperature and time period of main-heating processing can be set by a user. The program mode, in which, cooking temperature and time period of main-heating processing is preset. When the manual mode is selected, cooking can be done in conventional style which, the user checks progression during cooking. When the program mode is selected, the cooking apparatus performs the initial-heating processing and main-heating processing to provide consistent quality of the cooked foodstuff. Further, in this embodiment, selection of perform or not perform the initial-heating process is done by selection of manual mode or program mode. Buttons for selecting perform or not to perform the initial-heating process may be provided on the control panel 60.

In the embodiment described above, the controller 70 variably controls the input electricity for the heater 20 through driving circuit 74 to rise the inside temperature of the cooking chamber11 to go match with the temperature rising line. The invention is not limited to this embodiment, the controller 70 may control the heater 20 by on and off. In this case, control accuracy may be low compared to the one variably controlling the electricity supply to the heater 20, however, it is possible to rise the inside temperature of the cooking chamber 11 to go match with the temperature rising line.

### REFERENCE OF NUMERALS

10 . . . Cooking apparatus (Steam convection oven), 11 . . . Cooking chamber, 20 . . . Heater, 30 . . . Fan, 40 . . . Steam generating device, 70 . . . Controller, 74, 76 . . . Driving circuit

1. A cooking apparatus comprised of a cooking chamber which made to contain a foodstuff inside, a heater for heating interior of said cooking chamber, an electric fan generating convectional flow of air heated by said heater in the cooking chamber, a cooking chamber temperature sensor for detecting inside temperature of cooking chamber, cooking temperature setting means for preset cooking temperature suitable for foodstuff contained in the cooking chamber and a controller for controlling inside temperature of the cooking chamber by performing a pre-heating processing which rises inside temperature of the cooking chamber up to said predetermined cooking temperature by controlling electricity supply for the heater in response to value detected by the cooking chamber temperature sensor before said foodstuff being placed in the cooking chamber and a main-heating processing which rises and maintains inside temperature of cooking chamber at said predetermined cooking temperature by controlling electricity supply for the heater in response to value detected by the cooking chamber temperature sensor when the inside temperature of the cooking chamber is dropped by the food stuff being place in the cooking chamber:
wherein, said controller comprising a control means performing an initial-heating processing before transition to said main-heating processing which rises inside temperature of the cooking chamber being match with a temperature rising line that regulates temperature rising rate which provided in relation of elapsed time in predetermined initial-heating processing time period and temperature change from initial-heating start temperature to said preset cooking temperature in response to temperature detected by the cooking chamber temperature sensor when the inside temperature of the cooking chamber is dropped by the food stuff being place in the cooking chamber.

2. A cooking apparatus as claimed in claim 1, wherein the cooking apparatus comprises a steam generating device for supplying steam into said cooking chamber and said controller comprising a control means for controlling electricity supply for an electric heating means in the steam generating device together with said heater in response to value detected by the cooking chamber temperature sensor during said initial-heating processing.

3. A cooking apparatus as claimed in claim l, wherein the cooking apparatus comprises a induction heating type steam generating device for supplying steam into said cooking chamber and said controller comprising a control means for controlling electricity supply for an electric heating means in the steam generating device together with said heater in response to value detected by the cooking chamber temperature sensor during said initial-heating processing.

4. A cooking apparatus as claimed in claim 1, wherein the controller stops the electricity supply for said heater until the cooking chamber temperature detected by the cooking chamber temperature sensor being match with the temperature rising line, when the inside temperature of said cooking chamber does not drop below the initial-heating start temperature when the foodstuff is placed in the cooking chamber.

5. A cooking apparatus as claimed in claim 1, wherein the cooking apparatus comprises a manual mode in which, cooking temperature and time period of main-heating processing can be set by a user and a program mode, in which, cooking temperature and time period of main-heating processing is preset and arranged to selectable between two modes.
